(19) United States
(12) Patent Application Publication
(10) Pub. No.: US 2007/0196196 A1
(43) Pub. Date: Aug. 23, 2007

(54) High strength fastener system

(76) Inventors: Detlef T. Schorling, (US); Nancy Kay Keech, Ladera Ranch, CA (US)

Correspondence Address: Detlef T. Schorling, 1077 E. Pacific Coast Hwy. # 310, Seal Beach, CA, 90740, US

(21) Appl. No.: 11/699,978

(22) Filed: Jan. 30, 2007

Related U.S. Application Data
(60) Provisional application No. 60/776,111, filed on Feb. 23, 2006.

(51) Int. Cl. F16B 21/00

(52) U.S. Cl. 411/555

(57) ABSTRACT

A fastening system to press together 2 work pieces. These are plates with a circular aperture on each plate. The first work piece is engaged to the second work piece through a biased engagement. The receptacle assembly consists of a housing and its mechanical contents attached to the first work piece. The bolt assembly consists of a cylindrical bolt with a head and a shank attached and captured thru a retaining bracket to the second work piece and is moveable with respect to the receptacle assembly between the extended and retracted position. Two or more disc springs inside the housing bias the fastener toward the locked position with a biasing force. The bolt fastener has 2 opposing spiral cam slots machined on its shank and when introduced into the pin ring, inside the housing, will engage 2 radial placed cross-pins in its cam slots. Said cross-pins are seated in the pin ring. When the bolt fastener is rotated from the extended position to the retracted position it will lift the cross-pins and with it the pin ring against the disc springs and compressing them so as to provide a biasing force to press the first work piece in engagement with the second work piece.

This application claims the benefit of provisional patent application Ser. No. U.S. 60/776,111, filed Feb. 23, 2006 by the present inventors.

### FEDERALLY SPONSORED RESEARCH

Not applicable

### SEQUENCE LISTING OR PROGRAM

Not applicable

### FIELD OF INVENTION

Fastener

Reference cited:

| | | |
|---|---|---|
| US patents: | | |
| 3,874,041 | Smith, | 1975 |
| 4,067,090 | Schenk | 1978 |
| 4,227,287 | Gunther | 1980 |
| 4,308,646 | Schenk | 1982 |
| 4,378,615 | Gunther | 1983 |
| 4,522,541 | Bidwell | 1985 |
| Pub. No. | | |
| US 2005/0008458 A1 | Keech | (abandoned) |

### BACKGROUND OF THE INVENTION

Quarter turn fasteners of the quick release type, are well known and have been in use for many years. The present disclosure overcomes some of the shortcomings with prior art fastening systems that include S-shaped coiled springs or helical springs which show in special applications fatigue limitations and limited resistance to vibrations, limited cycle time and limited G-forces. Previous designs show bolt fasteners having a hollow end and having two spiral cam slots on the shank of the bolt fastener cutting thru to this hollow end. A cross pin of limited diameter goes thru these spiral cam slots across the bolt fastener. The hollow end and the two cut thru cam slots remove a lot of material from the bolt shank and created together with the cam cut-out 2 cantilevers on the end of the fastener, which weakens the fastener against axial forces. Cross pins of limited diameter can take only limited bending forces. Some of the designs of previous art show all the parts, or some of the parts exposed to dirt and weather. Some of the designs show bolt tracks of inefficient manufacturing design. In addition it has been difficult to retain a bolt fastener together with the second work piece, as some of the designs show them as non-captive and the bolt fastener might be misplaced or lost when disengaged from the first work piece.

This high strength fastener is particularly designed to work in high vibration areas on aircraft and especially in helicopters which have a combination of strong vibrations and high g-forces, where a strong clamping force is required but where easy and quick assembly and disassembly with common hand tools is a required. Previous designs have shown that common fastener of quarter turn design either fatigued prematurely in this environment, fail structurally and brake, or eat themselves into the skin of the aircraft. This results in repeated downtime and expensive repairs. Another requirement in this industry is that the fastener has to be able to withstand repeated assembly and disassembly calling for up to 5000 cycle per fastener. Another consideration is the fact that the fastener has to resist weather and dirt penetration, and that it has to be attached to the skin by riveting or other reliable attachment means. U.S. Pat. No. 4,522,541, Bidwell, U.S. Pat. No. 4,308,646 Schenk, U.S. Pat. No. 3,874,041 Smith, shows a rectangular semi enclosed housing, made of plate material, with a helical spring, thin tabs or cross members are reaching into the spiral cam slots they are of rectangular design with sharp corners, which will not hold up in a high vibration area because of stress points on the corners and eating of corners. U.S. Pat. No. 4,227,287, Gunther, U.S. Pat. No. 4,378,615, Gunther, have an enclosed housing but act on a relative thin cross pin and use a bore in the lower part of the bolt with additional cut out tracks, which weakens the bolt and creates 2 cantilevers on the bolt end. They use helical springs as means of bias. U.S. Pat. No. 4,067,090, Schenk, is different in character, totally open and use tabs with sharp corners. Published and abandoned patent Pub. No. US2005/0008458, Keech, uses a thin cross pin and hollowed bolt with cantilever problems and has the disc springs on the outside exposed to weather. U.S. Pat. No. 4,442,561 Gunther, shows a slotted fastener, similar to our design. The difference is in the design of the cam slot. The patent shows a track with a steep “substantial continues radius of curvature” as claimed. Further in the description the detent is mentioned that a “depression is cut”, which creates a sharp “hump”. Our design critically avoids this sharp hump but shows in its character a shallow summit area. Our helix is not steep and radius like but is a straight helix on a shallow climb angle. Our bolt tracks are more than quarter turn and likens more to a third turn covering up to 120 degrees of bolt rotation. Our cross pins are short and thick of hardened and ground material and are captured in the pin ring. They can rotate in the pin ring when climbing the cam slots. In our preferred embodiment we use stacks of disc springs which require high forces to compress on very limited travel. The housing is totally enclosed and encapsulated with a lid. All the parts are pre assembled and package as a receptacle assembly and a bolt assembly. All what the assembler has to do is to rivet these assemblies to the upper and lower work pieces.

This fastening system has the advantage over previous art that it is easy and fast to install and remove with common tools, it is a robust and durable design for the high vibration environment,and needs only a 90 to 120 degree rotation of the bolt fastener. The bolt fastener is solid and not hollow at its shank end. The design has an enclosed housing which prevents moisture and dirt to enter the internal parts.

The cross-pins which engage in the opposing spiral cam slots of the bolt fastener are short and larger in diameter, designed for high shear forces and they can turn when climbing the cam slots of the bolt fastener this motion reduces friction and increases the life of the part. The springs are of the disc spring (Belleville washer) type which have the characteristic to create high spring forces on very small incremental compression. Placed in the receptacle assembly beneath the bolt fastener is a helical coil spring. When the bolt fastener is not engaged, said bolt fastener is lifted by the helical coil spring. This way the head of the bolt fastener will protrude, and indicate to the operator that this fastener is not tightened.

### SUMMARY

The high strength fastening system of the present disclosure consists of a bolt fastener assembly and a receptacle assembly which is designed to press together plate members here called work pieces. The work pieces comprise mainly of a lower and an upper plate with circular apertures in each plate. The first work piece which is the lower plate member is engaged to the second work piece which is the upper plate member thru a biased engagement. The first work piece consists of a receptacle that is a cylindrical housing that forms 2 chambers. The second work piece consists of a bolt with a head and is able to slide with respect to the receptacle between an extended and retracted position. Two or more disc springs also called “Belleville washers” bias thru resilience the bolt towards the locked position with a biasing force. The bolt fastener has 2 spiral indentations 180 degrees offset on its shank, which is adaptable to be inserted into a member of the receptacle. When the bolt fastener is rotated a pair of cross pins seated in the pin ring follow the cam slots in the bolt fastener upwards and they lift the pin-ring towards the disc springs and compresses them so that a force is transferred thru the bolt fastener, and bolt fastener head, to the second work piece, which will exert a biasing force against the first work piece. As the first work piece is detained by the bolt fastener head, clamping is archived between the first work piece and the second work piece.

The bolt fastener assembly and the receptacle assembly are configured such that they may attach or release with more of a quarter turn up to a third turn of the bolt fastener, the bolt fastener having a slot or other turning means on its head to accommodate a screw driver or other tools to exert torque on the bolt fastener. Additional features of the present disclosure will be shown and become apparent to those skilled in the art, upon explanation and description of the drawings.

### GENERAL DESCRIPTION OF THE DRAWINGS FIGURES

FIG. 1 is a cross-sectional view of the bolt assembly and the receptacle assembly.

FIG. 2 is a perspective view of the bolt assembly and the receptacle assembly.

FIG. 3 shows a perspective view of the first and second work piece, the bolt fastener is tightened.

FIG. 4 shows a perspective view of the first and second work piece engaged, but the bolt fastener is not tightened (sticking out)

FIG. 5 shows a cross section of the assembly. The first and second work pieces are in contact and the bolt fastener is tightened. The disc springs are compressed.

FIG. 6 shows a perspective cross section with the first and second work piece in contact. The bolt fastener is in position but not tightened.

FIG. 7 shows an exploded perspective cross section view of the bolt fastener assembly and the receptacle assembly.

FIG. 8 shows an exploded view of the receptacle assembly.

FIG. 9 shows a perspective cross section of the assembled fastener. An o-ring is added and a drain hole is shown.

FIG. 10 shows an exploded view of FIG. 9

FIG. 11 shows a view from below where a housing with a narrow attachment flange and narrow housing lid is mounted to the first work piece.

FIG. 12 shows a cross section of the assembled fastener, showing a strong helical spring as the biasing element, instead of disk springs.

FIG. 13 shows the first work piece having several disc springs, stacked in parallel and in series.

FIG. 14a, 14b, 14c, show pin ring arrangements with pins of different configurations.

FIG. 17a, 17b, 17c, show the bolt fastener with different groove-configurations of the opposing spiral cam slots.

FIG. 18 shows a cross section of a receptacle assembly designed with a groove in-cut in the housing, and a snap ring located in the groove.

FIG. 19 show the same as FIG. 18 but in perspective view.

FIG. 20 shows the fastener assembly in cross sectional view. The helical coil spring is located in the pocket of the retaining bracket. The bolt fastener is engaged and the helical coil spring is contracted.

FIG. 21 shows the fastener assembly in a cross sectional view. The fastener bolt is disengaged and the helical coil spring expanded. The bolt fastener sticks out.

FIG. 22, 23, 24, 25, 26, 27 show anti-rotation versions of the receptacle, in perspective and exploded view.

FIG. 31 shows a housing with a serrated rim on its upper edge assembled with the first work piece.

FIG. 32 shows an exploded view of the housing and the first work piece. The housing shows said serrated rim.

FIG. 33 shows a bolt fastener with the curve profile of the opposing spiral cam slots.

FIG. 34 shows a cross section of a bolt fastener with an integrated inner element.

FIG. 35 shows an exploded view of the bolt fastener with an integrated inner element.

### DETAILED DESCRIPTION

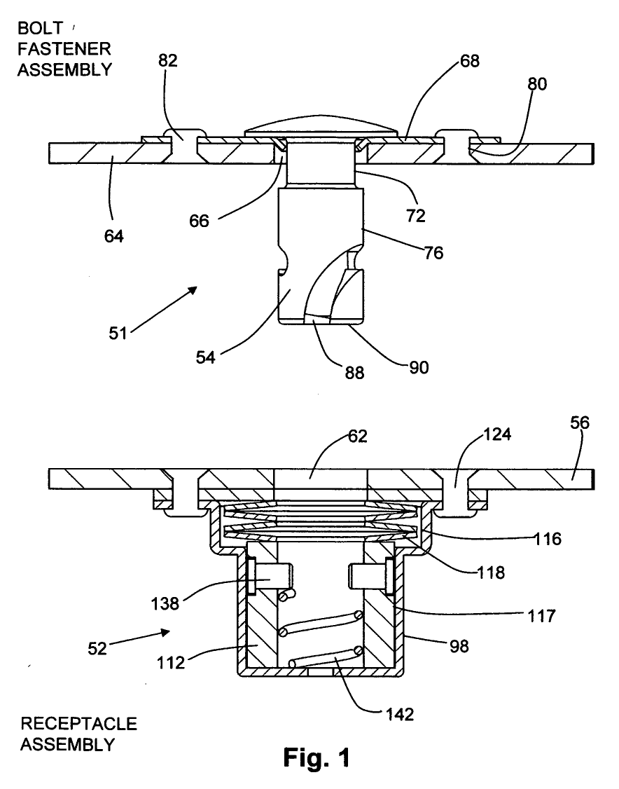

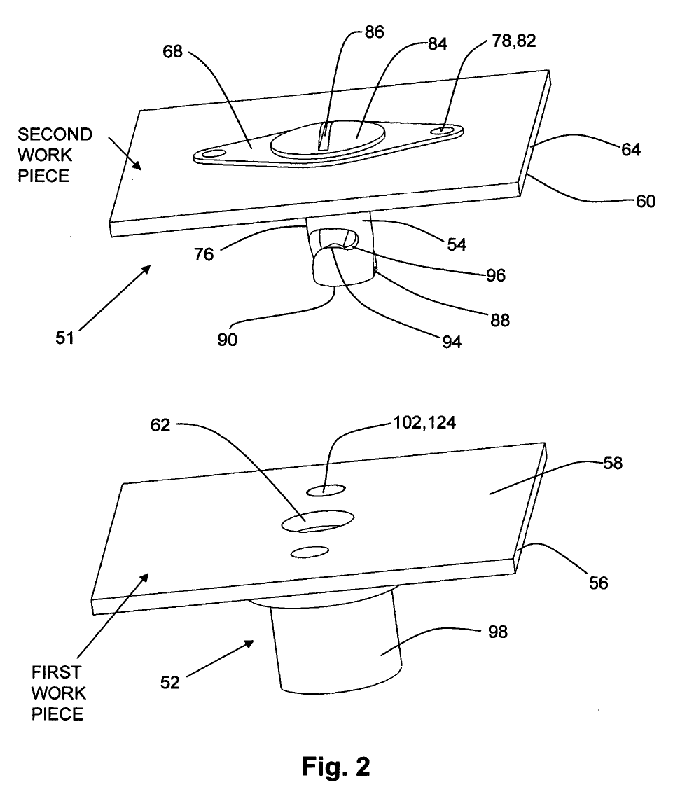

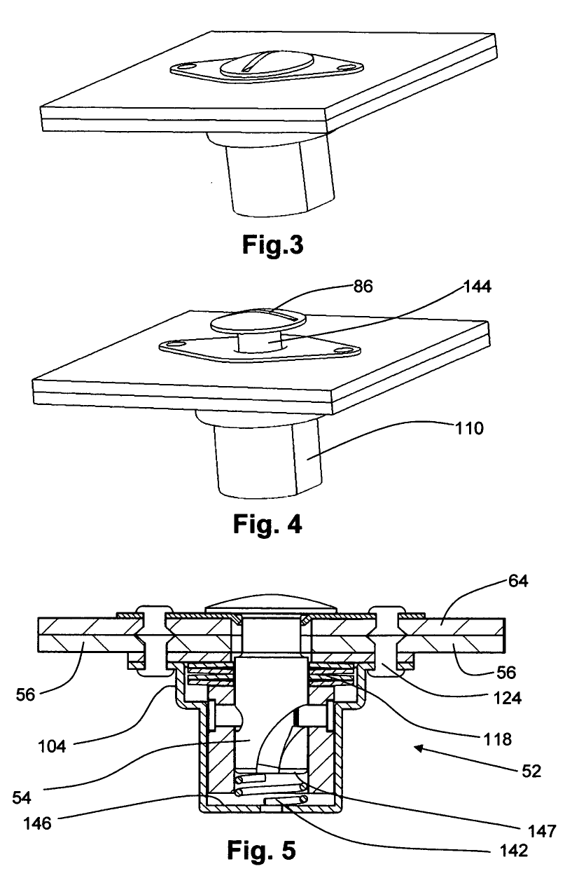

The high strength fastening system of the present disclosure in FIG. 1 and 2 includes a receptacle assembly 52 and a bolt fastener assembly 51.

The receptacle assembly 52 is designed to be attached to the first work piece 56 such as a plate, having a flat surface around the fastener area 58 and a flat parallel surface on the other side of the first work piece. The first work piece 56 has a round bore 62. The bolt fastener 54 in FIG. 1, 2 is attached to a second work piece 64 which is a plate with 2 parallel surfaces. The bore 66 FIG. 1, 7, is created to accommodate the bolt fastener 54 shown in FIGS. 1 and 7.

The bolt fastener 54 is secured into place by a retaining bracket 68 in FIG. 1, 7. This retaining bracket 68 has an aperture 70 in FIG. 7, which is less in diameter than the shank diameter 76 of the bolt fastener 54, and as the bolt fastener 54 has an incut 72 FIG. 1, 7 which is smaller in diameter than the aperture 70 FIG. 7 in the retaining bracket 68. The bolt fastener 54 has play along its axis but will be captive along the incut 72 FIG. 7, and will not fall away or get lost. The retaining bracket 68 has been crimpt 74 FIG. 7, at its aperture 70 which will reduce the aperture 70 relative to the bolt fasteners outside diameter 76 FIGS. 1, 7 and hold the bolt fastener 54 captive.

The retaining bracket 68 has holes 78 FIG. 2, and the second work piece 64 has matching holes 80 FIG. 1. These holes are in line, and the 2 pieces are held in place by means of rivets, screws or other fastener 82 FIG. 1.

The bolt fastener 54 FIG. 2, includes an enlarged head 84 with a slot 86 or the like, in the upper area, to rotate the fastener into its locked and unlocked position by means of a tool. On the underside of the head is a reduced diameter neck 72 FIG. 1. Beginning at the end of the shank 76 opposite to the head is a pair of opposing spiral cam slots 88 FIG. 1, 2. Each slot is cut from the leading edge 90 and extends along the shank towards the direction of the head 84. At a certain point the spiral cam slots 88 FIG. 2 tilts gradually more horizontal until they reach a maximum high-point in the curve. This would be called the dead point 94 FIG. 2 of the curve. The slot then starts to bend downwards and than comes to an end. This can be called the retaining area 96.

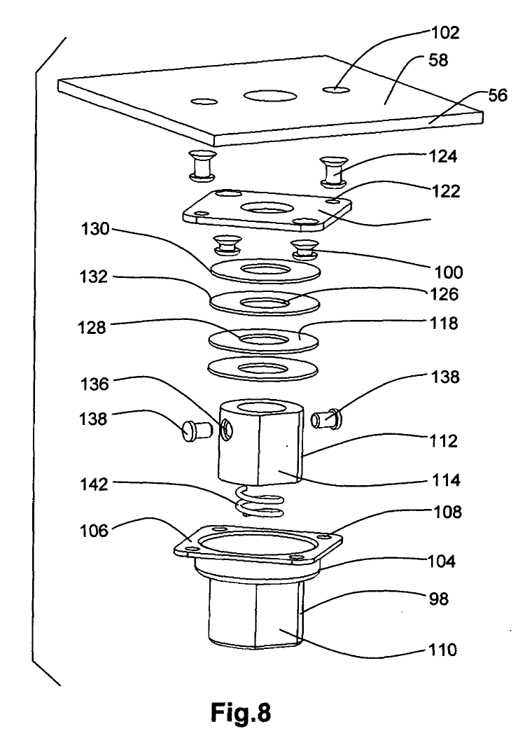

A housing 98 in FIGS. 1, 7 is attached to the first work piece 56 FIG. 1 by means of rivets, screws or other fasteners 124, FIG. 1, 7 which sit in pre drilled holes 102 FIG. 2, and FIG. 8, which match the first work piece 56, housing lid 120, and the housing 98. The housing 98 is hollow and is a stamped, drawn, machined or a sintered part. It steps up to an enlarged diameter 104 FIGS. 5, 7, 8 and a square or rectangular flange 106 FIG. 8, with 4 holes 108 for attachment rivets or other fasteners. The housing has a flat surface 110 FIG. 8, which serves as a detent against rotation of the pin ring 112 FIG. 8. This pin ring 112 has a matching flat surface 114 FIG. 8, which slides against the inside surface of the flat surface 110 in FIG. 8 of the housing 98. The housing is divided by a step into a upper chamber 116 FIG. 7 and a lower chamber 117. The upper chamber is designed so it will accommodate 2 or more disk springs 118, also called Belleville washers. The housing 98 has a housing lid 120 riveted to it. This housing lid 120 has 4 holes 122 FIG. 8. It is designed to accommodate 2 rivets 100 to capture and lock the housing 98 FIG. 8 with the housing lid 120, and 2 more rivets 124, diagonally placed to them to fasten the housing lid 120 together with the housing 98 against the first work piece 56. In this way the parts in the housing 98 are captured as an enclosed receptacle 52 before they get mounted to the first work piece 56.

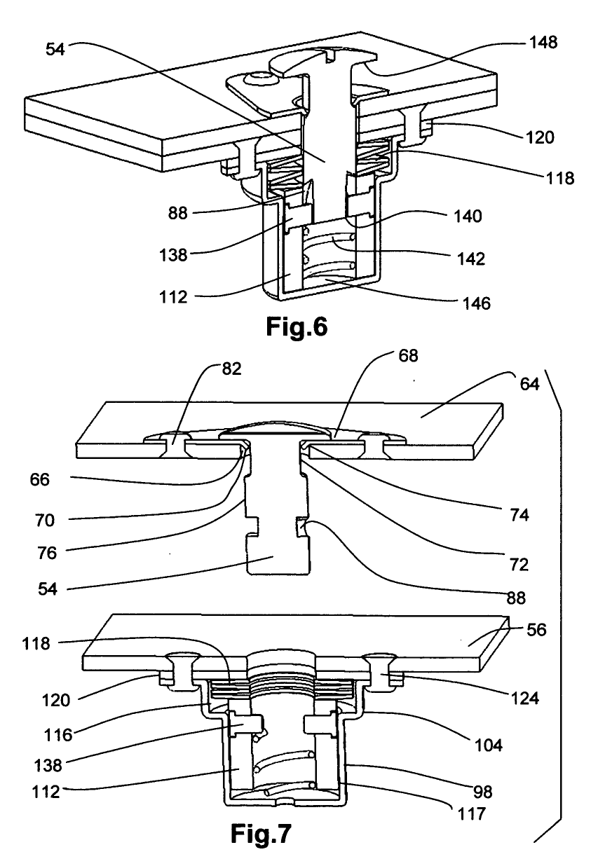

The disk springs 118 in FIG. 6, are captured between the housing lid 120 and the pin ring 112 with a slight preload. The disc springs 118 are also restricted to move radially or side ways by the circular enclosure of upper chamber 116 FIG. 7. These disc springs 118 can be stacked in such a way that the smaller inner peripheral edge of the disc springs 126 FIG. 8 is touching the smaller inner peripheral edge 128 of the next disc spring, and the larger outer peripheral edge of the disc spring 130 FIG. 8 is touching the larger outer peripheral edge of the next disc spring 132.

This results in an accordion like manner to stack the disc springs. When the stack is subject to a compression force in an axial or vertical direction, it will somewhat flatten and shorten, and when the force is removed it is getting longer and will return to its initial stack-height as shown in FIG. 6.

The pin ring 112 FIG. 8, is a circular tube with a flat anti rotation surface 114 machined into its cylindrical outer surface, and 2 drilled holes 136 FIG. 8 which are located radially to the axis of the pin ring 112. These 2 holes hold 2 cross-pins 138 which are held with a press fit or loose fit in the holes 136 FIG. 8. The cross-pins 138 are flush with the outside diameter of the pin ring 112 but protrude inward 140 FIG. 6 towards the centerline of the pin ring 112. The diameter of these cross-pins 138 is less than the width of the opposing spiral cam slots 88 FIG. 7 of the bolt fastener 54. The helical coil spring 142 FIG. 6, is slightly less in its outside diameter than the inside diameter of the pin ring 112. When the fastener bolt is in non engagement, the helical coil spring 142 has enough force to lift the fastener bolt 54 against its weight and friction, so that it visibly protrudes above the fastener assembly 144 FIG. 4. This indicates to the operator that this bolt has not been tightened yet. The helical coil spring 142 in its expanded state has a slight preload when it touches the two pins 138 FIG. 6, and is captured between the pins 138 and the bottom of the housing 146 FIG. 6.

First work piece 56 FIG. 1, second work piece 64, bolt fastener 54, retaining bracket 68, housing 98, pin ring 112 FIG. 1, 7, disc springs 118 FIG. 1, 8, housing lid 120, rivets 82, 100, 124, cross-pins 138, helical coil spring 142, this parts which when assembled represent the high strength fastener may respectably be formed from metallic and or non metallic materials as an example but not limited: Steel, stainless steel, all steel alloys, titanium, aluminum, all aluminum alloys, plastic and composite materials including graphite, carbon, quartz, glass polymers and cellulose.

OPERATION: Engagement and disengagement of the high strength fastener. The second work piece 64 FIG. 2 with the bolt fastener 54 attached, is introduced onto the first work piece 56 until surface 60 FIG. 2 touches surface 58 in FIG. 2. The bolt fastener 54 will than take the protruded position shown, 144 FIG. 4. By introducing a screw driver blade into the slot 86 FIG. 4 of the head of the bolt fastener 54 and doing a slight turn clock wise until the opposing spiral cam slots 88 FIG. 6 of the bolt fastener engage the cross-pins 138. Pushing the screw driver down will result in engagement of the cross-pins 138 into the opposing spiral cam slots 88 FIG. 6. The opposing spiral cam slots 88 are now not more vertical in relation to the pins 138 FIG. 6 but have a slope of approximately 30 degrees. As the bolt fastener 54 is turned clock wise with the screw driver, the head 84 of the bolt fastener 54 descends and touches with its underside 148 FIG. 6 the retaining bracket 68 FIG. 7 and the cross-pins 138 start to climb with the pin ring 112 up the opposing spiral cam slots 88 and lift the pin ring 112 against the stacked disc springs 118, and compressing them axially. The spring force increases steadily, as the pin ring is moved toward the spring stack. As soon as the cross-pins 138 reach over the dead point 94 FIG. 2 of the opposing spiral cam slot curvature, the compression force of the disc spring stack will force the cross-pins 138 down into the retaining area 96 FIG. 2 and create a locking action. This causes the disc spring stack to expand a small amount. The spring force will be still considerable and act as a lock-in force. This is caused with an approximately 90 to 120 degree turn of the bolt fastener 54. When unlocking, the sequence of events of the high strength fastener, are in reverse. The screw driver has to turn the bolt fastener 54 counter-clock wise and overcome the spring force by compressing the stacked disc springs FIG. 7 until the cross-pins 138 are over the dead point 94 FIG. 2 in the opposing spiral cam slots 88. The stacked disc springs will release the spring force and return to its original stack height as the bolt fastener 54 turns. The bolt fastener 54 turns back to its starting angle. At the end of the turn, the bolt fastener has no vertical resistance from the cross-pins 138 FIG. 6, as the opposing spiral cam slots 88 are vertical or almost vertical in relation to the cross-pins 138. The helical coil spring 142 FIG. 6 will push the head up as shown in 144 FIG. 4. If this fastener is in a row of fasteners, the operator will see that the head of this fastener sticks out and will know that this fastener is unlocked.

### Additional Embodiments

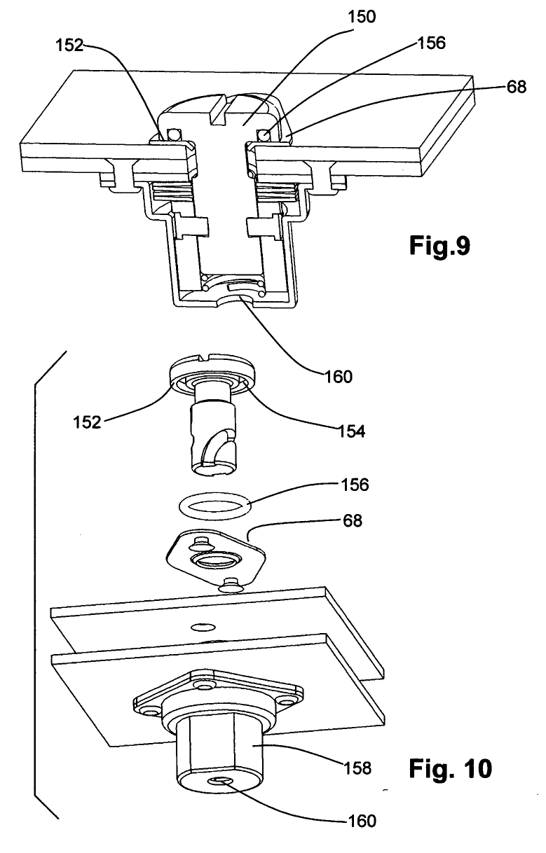

Another embodiment of the fastening system is shown in FIG. 9 and 10. The bolt fastener of this configuration has on the under side of the head 152 FIG. 9 a concentric groove 154 FIG. 10 which accommodates an o-ring 156 of soft rubber material or other plastic composites, which presses in the locked position against the retaining bracket 68. This way moisture is prevented to enter the fastening system from the outside of the aircraft when it is in a locked position shown in FIG. 9, in addition a drain hole 160 is added to the bottom of the housing 158 located on the inside of the air craft. This eliminates moisture accumulation.

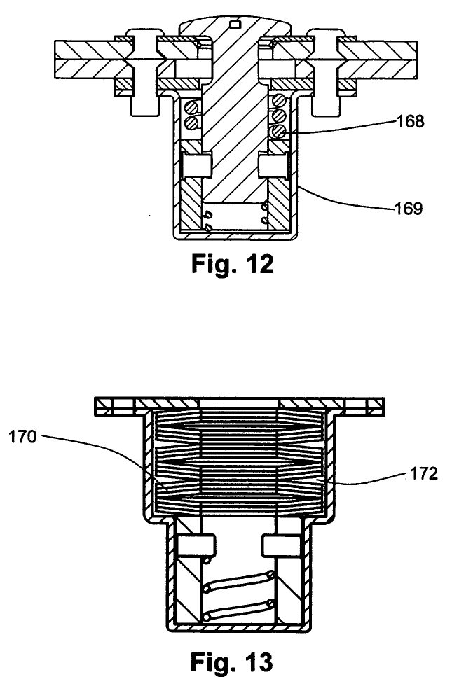

Another embodiment of the fastening system is shown in FIG. 12. The disc springs 118 FIG. 7 are replaced by a very strong helical coil spring 168 FIG. 12.

The housing has no step.

Another embodiment of the fastening system is the manner of arranging disc springs as shown in FIG. 13. To increase the spring force the disc springs are stacked in parallel 170 FIG. 13. Example: Picture shows 3 disc springs stacked, and than the packet of parallel disc springs are stacked in series 172 FIG. 13.

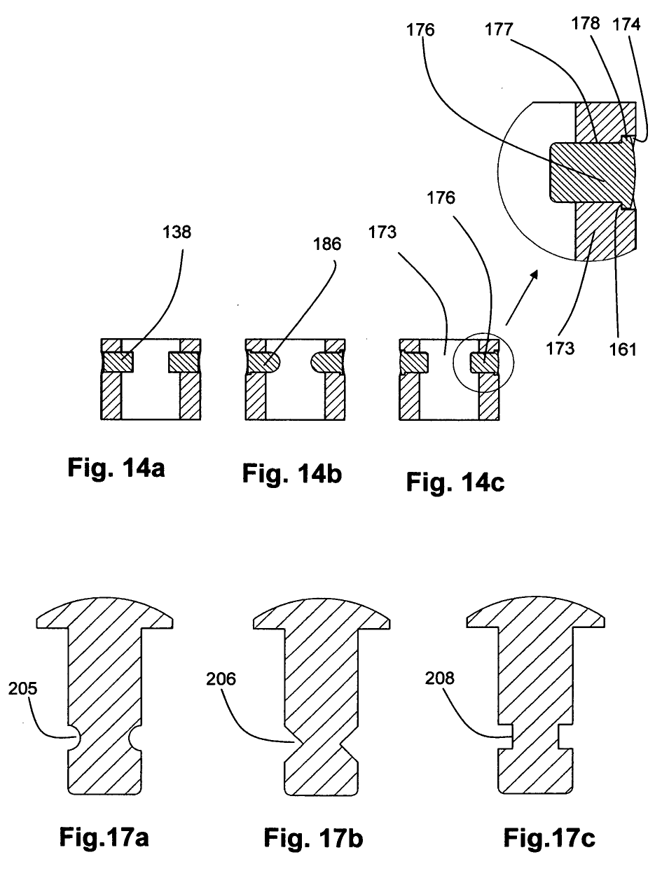

Another embodiment of the fastening system is the manner to seat the cross pins to the pin ring. FIG. 14a shows a straight cross-pin 138 which is seated in the pin bore with a press fit.

Another embodiment of the cross pin is shown in FIG. 14b, the cross pin having a rounded end 186.

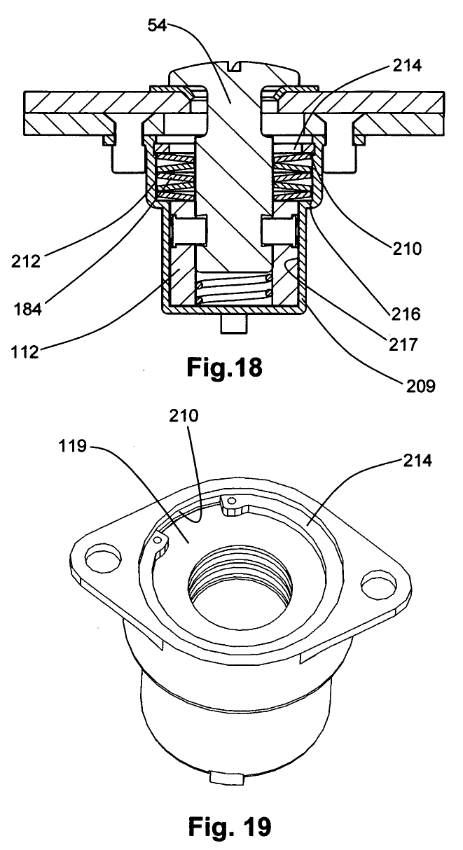

FIG. 14c shows a pin ring 173 with a counter sunk bore 174 on both sides. The cross-pins 176 have a flange 178 which are seated in the counter sunk bore 174. This way the pin is captured between the inner surface 161 of the countersink 174 and the inner wall side of the housing FIG. 18 item 217. The fit between the cross-pin 176 and the bore 177 is either a loose fit so that the pin 176 can freely turn, or a press fit where the cross-pin is firmly in place and can not turn.

Another embodiment of the fastening system FIG. 17a, 17b, and 17c shows cross-sections of the bolt fastener with different configurations of the opposing spiral cam slots. FIG. 17a shows a bolt fastener with rounded opposing spiral cam slots 205. In FIG. 17b shows a bolt fastener with tapered opposing spiral cam slots 206. FIG. 17c shows a bolt fastener with square opposing spiral cam slots 208.

Another embodiment of the fastening system is shown in FIG. 18 and FIG. 19. The housing 209 lacks the housing lid 120 FIG. 7. There is a groove 210 FIG. 19 placed on the inner diameter of the housing 212, which accommodates a snap ring 214. The disk springs packet 184 FIG. 19 is located between the snap ring 214 FIG. 18 and the housing step 216. This way the disk spring packet 184 is captured with a slight preload between the snap ring 214 and pin ring 112.

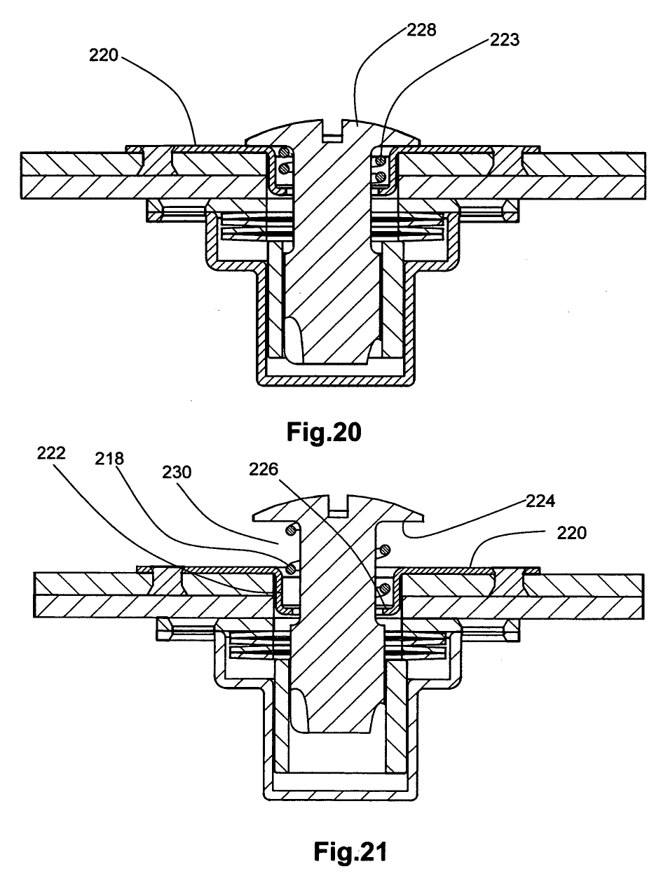

Another embodiment of the fastening system is shown in FIG. 20 and 21. Previously a helical coil spring was shown in FIG. 5 item 142 between the bottom of the housing 146 and on the lower end 147 of the bolt fastener 54. In this version of the embodiment of the fastening system, a helical coil spring 218 FIG. 21 is shown to be located underneath the bolt fastener head 224 and seated on the bottom 226 of the spring chamber 222 formed by the retaining bracket 220 FIG. 21. The bracket is crimped to form said bottom 226 FIG. 20 to be able to retain the bolt faster. This design shows the operator that when the bolt fastener 228 is disengaged it is sticking up 230 due to the force of the helical coil spring 218 and when the bolt fastener 228 is engaged it is pressing down with the underside of the head 22 against the retaining bracket 220 and compressing the helical coil spring.

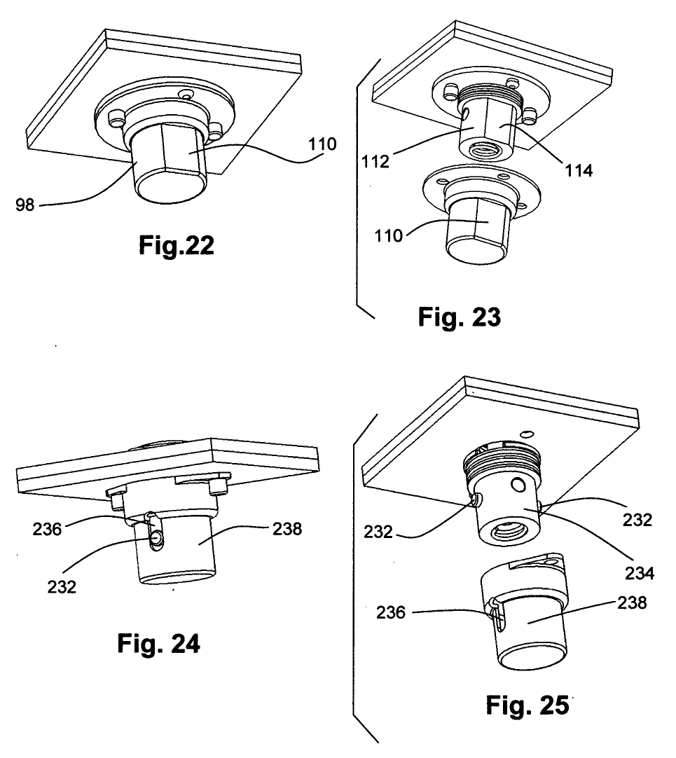

Other embodiments of the fastening system are shown in FIG. 22 to FIG. 27. One of the important objectives of this invention is to have a simple but efficient anti-rotation feature to prevent the pin ring to rotate, when the bolt fastener 54 FIG. 18 is turned, but by the same time to allow the pin ring 112 FIG. 18 to easy slide up and down and compress or release the disk spring stack 184.

This is shown in the preferred embodiment of the fastening system presented in FIG. 22 and 23. A flat surface 114 in the pin ring 112 contacts the flat inside surface 110 of the housing 98.

Another embodiment of the fastening system is shown in FIG. 24 and 25. One or two bolt-pins 232 are sticking out on one, or on opposite sides from the outside surface 234 FIG. 25 of the pin ring. These bolt-pins 232 run in a corresponding vertical slot 236 FIG. 24 of the housing 238. Said bolt pins serve as an anti rotation devise.

Another embodiment of the fastening system is shown in FIG. 26 and 27. A pin ring 240 is shown with 1 or 2 protruding vertical guides 242 protruding from the lower end of the pin ring 244. Said guides 242 engage into 1 or 2 in-cuts 246 at the bottom 248 of the housing 250. The guides are long enough to stay engaged into the in-cuts 246 to cover the full length of the vertical travel of the pin ring 240. Said guides serve as an anti rotation device.

As shown previously in FIG. 5, the receptacle 52 and all its contents attach to the first work piece 56 by means of rivet, blind rivets, screws or other fastening elements 124.

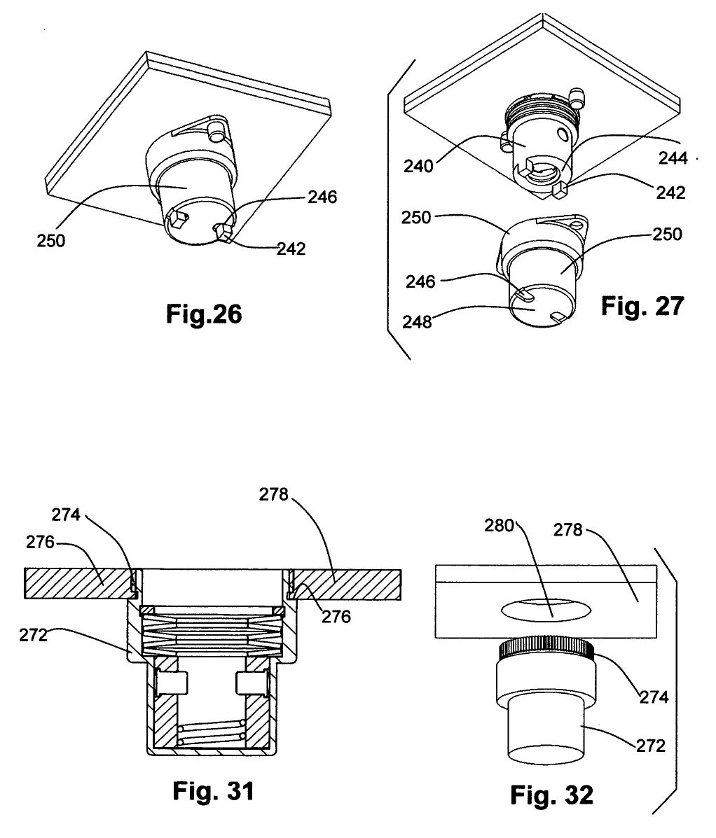

Another way to attach the receptacle is shown in FIG. 31 and 32, providing a self clinching serrated toothed rimmed surface 274. The serrated toothed rimmed surface ends in a shoulder stepped in-cut 276. When the housing 272 is pressed with its rim into the bore 280 of the first work piece 278 it will create a solid mounting for the receptacle.

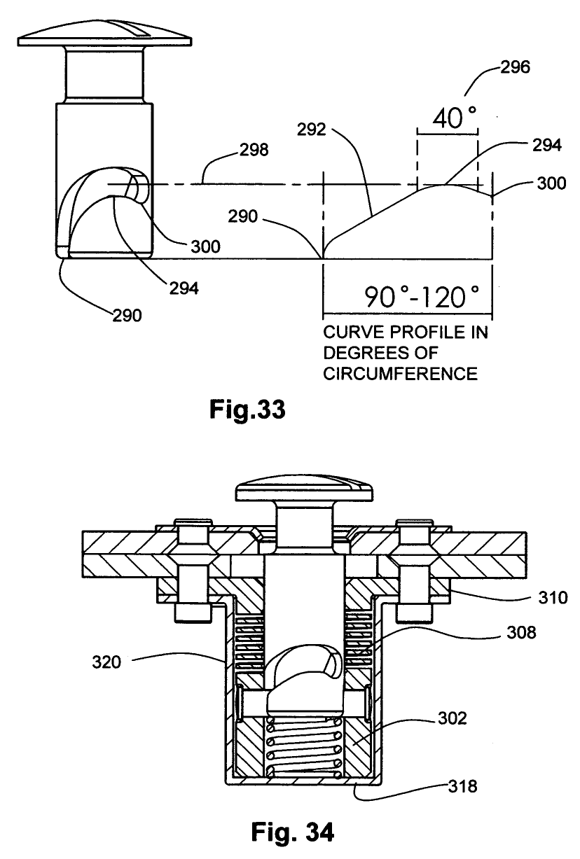

Another embodiment of the fastening system is shown in FIG. 33. The curve profile of the fastener shows special characteristic. Conventional quarter turn designs show a track in the bolt fastener where the curve starts at the distal end and continues in a curved radius-type helix. Our fastener enters vertical 290 at the distal end of the bolt fastener curves into a straight helix 292 of approximately 30 degrees incline, climbing the bolt fastener shank until it reaches the summit of the curve, here called the dead point 294. This summit area covers 40 degrees of rotational movement 296. The centerline 298 of the cam profile has a very shallow curve incline, and when leaving it ends in a retaining area 300. The whole track is a continuous machined in-cut by CNC technology, or manufactured by cold forming or forging.

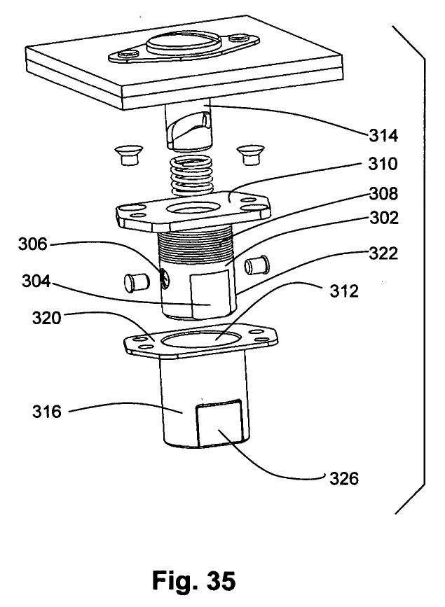

Another embodiment of the fastening system is shown in FIG. 34 and 35. Pin ring, housing lid and a strong helical spring become one integral part here called inner element 302. The inner element has a flat anti rotation surface 304, bores for the cross-pins 306, a helical spiral in-cut creating a spring 308 and a housing lid 310. The internal bore has a loose fit with the bolt fastener 314. The housing 316 has a cylindrical shape with a bottom 318 and a flange 320. The outside diameter of the integrated element 322 has a loose fit with the inside diameter of the housing. The anti rotation surface of 304 of the inner element has a sliding fit with the inside of the flat surface 326 of the housing.

Although the description above contains many specificities, these should not be construed as limiting the scope of the invention but as merely providing illustrations of some of the presently preferred embodiments of this invention.

We claim:

1. An improved high strength fastener system for removably attaching a first work piece in biased engagement with a second work piece, the fastening system comprising;
a) a housing having a central axis, having a housing flange at its upper end, a cylindrical side wall and a cylindrical inner wall-surface and a bottom, forming a hollow space and forming an upper and a lower chamber divided with a step between them, the housing having an anti rotation means,
b) a lid to cage the internal parts of the housing, fastened with rivets to said housing,
c) a plurality of biasing members inside said housing each biasing member comprising of disc springs, stacked in parallel and in an accordion type manner, sandwiched between said lid, and
d) a pin ring having a cylindrical outer surface and an internal bore, being slide-ably connected to said cylindrical inner wall surface of said housing and having an anti rotation means against said housing, slide-ably touching said anti rotation means of said housing, having two horizontal radial bores to accommodate
e) a pair of cross pin means, said cross pin means being slide-ably movable around their axis, seated in said pin ring and extending each with one end toward
f) a bolt fastener, comprising of an enlarged head, a smaller diameter shank, an even smaller diameter neck, said neck located adjacent to the head, said shank having two opposing spiral cam slots, said cam slots having a dead point and a retention area in said cam slots, said cross pin ends being adapted to be located within said opposing spiral cam slots, said bolt fastener being able to slide-ably move along its axis, being captured by
g) a retaining bracket, said retaining bracket having a slightly smaller crimped aperture than the shank diameter of the bolt fastener and capturing said bolt fastener along the length of the neck area, said retaining bracket being attached by fastening means to the second work piece,
h) a helical spring means, urging said bolt fastener out of said housing when said bolt fastener is in the extended free position to show to the operator that said bolt fastener is not engaged,
i) a plurality of rivets or other fastening means to attach the housing and said lid to the first work piece;
whereby;
when rotating the bolt fastener with a tool said bolt fastener will force said cross pin ends to climb said opposing spiral cam slots with minimum friction, due to their freedom to rotate, reaching over a dead point and snapping into the retention area of said opposing spiral cam slots, and force said pin ring in an axial movement against said disc springs and compressing said disc springs, creating a resilient biasing force and consequently pressing the second work piece against the first work piece.

2. The improved high strength fastener system as set forth in claim 1 wherein said bolt fastener is secured into place by said retaining bracket, said retaining bracket is secured by rivets to the second work piece, said retaining bracket has an aperture which is crimped and its diameter is less than the outside diameter of the bolt fastener shank, but is larger in diameter than the bolt fastener neck in-cut, said bolt fastener has play along its axis, but this play is limited by the length of the bolt fastener neck in-cut, to capture the bolt fastener with said retaining bracket.

3. The improved high strength fastener system as set forth in claim 2 wherein a retaining bracket with a deep drawn spring chamber is seating a spring on the bottom of said spring chamber and the spring is captured between the bottom of said retaining bracket and the bolt fastener head, the bottom of the spring chamber is crimped to capture the bolt fastener, the spring has just enough force to urge the bolt fastener out of the housing against gravity and friction.

4. The improved high strength fastener system as set forth in claim 1 wherein said pin ring has a cylindrical outer surface and a concentric bore, said cylindrical outer surface has a loose fit with the cylindrical inner wall of the lower chamber of said housing, said concentric bore of the pin ring has a loose fit with the cylindrical surface of the shank of said bolt fastener, said circumference of the pin ring has a flat surface, which slides tightly against said inner flat surface of the housing, preventing the pin ring to rotate around its axis, but allowing it to easily slide up and down along its axis, said pin ring has a line bore radial to its axis, which creates 2 bores in the pin ring wall, said bores have counter sunk in-cuts on the ends which borders to the outer circumference of the pin ring.

5. The improved high strength fastener system as set forth in claim 1 wherein a pair of cross-pins have a flange on one side and a flat ending on the other side, said cross-pins are seated with a loose fit in the bores of said pin ring and can rotate in said bores, said cross pins are captured with their flange between the wall of said housing and the countersunk in-cut of said pin ring, said cross pins are able to roll in the opposing spiral cam slots of said bolt fastener shank.

6. The improved high strength fastener system as set forth in claim 5 wherein said pin ring has a press fit with a pair of straight cylindrical, flange-less cross-pins, said cross-pins are rigidly connected to the pin ring and can not be turned.

7. The improved high strength fastener system as set forth in claim 5 wherein said cross-pins have a rounded pin end on the side which reaches into the bolt fastener.

8. The improved high strength fastener system as set forth in claim 1 wherein said housing has a cylindrical outer surface and a flange, to attach said housing lid by means of rivets to the housing, said housing has a step where the diameter decreases to form a smaller lower chamber, the disc springs are accommodated in an upper larger chamber, the pin ring is seated in said lower chamber with a loose fit to the inside surface of the housing, said housing having a flat surface to stay in tight contact with the flat surface of the pin ring, said housing has a drain hole in the center of said bottom of the housing.

9. The improved high strength fastener system as set forth in claim 1 wherein a helical coil spring is seated inside the pin ring and is slightly less in its outside diameter than the inside diameter of the pin ring bore, said helical coil spring is designed to a strength which is just slightly higher than the strength to urge the bolt fastener out of the housing against gravity and friction, in its expanded state said helical coil spring is captured with a slight pre load between said bottom of the housing and the lower part of the pins, when the bolt fastener is in engagement the helical coil spring will be compressed, when the bolt fastener is disengaged the helical coil spring is expanding and will lift said bolt fastener up so that the head of said bolt fastener visibly protrudes above the retaining bracket, to indicate to the operator that this fastener is not tightened.

10. The improved high strength fastener system as set forth in claim 8 wherein said disc springs, also called belleville washers, are captured between the housing lid and the pin ring with a slight preload, said disc springs are prevented to move sideways by the circular inner enclosure of the upper chamber of the housing, said disc springs are stacked in series, said disc spring are stacked in such a way, that the smaller inner peripheral edge of one disc spring is touching the smaller peripheral edge of the next disc spring and the larger outer peripheral edge of the disc spring touches the larger outer peripheral edge of the next disc spring, in such a way that the disc springs are stacked in an accordion like manner; when the stack is subject to a compression force in an axial direction, it will somewhat flatten the stack and shorten it, and when the force is removed it will expand, and return it to its initial stack height, the upper area of the pin ring will touch the inner peripheral edge of the lowest disc spring and while moving upward against the disc springs, shorten the disc spring stack, the center hole opening of the disc springs is larger than the outside diameter of the bolt fastener shank and has enough play margin that when the disc spring are compressed, it will not strangle or impede the axial movement of the bolt fastener.

11. The improved high strength fastener system as set forth in claim 1 wherein said bolt fastener is a solid fastener with an enlarged head designed to engage a hand tool to rotate the bolt fastener about its long axis, a neck area reduced in diameter adjacent to the head, to capture the bolt fastener, and a shank area which is larger in diameter than the neck area and which goes from the neck area to the distal end of the bolt fastener, said shank area has 2, 180 degree opposing spiral cam slots with a rectangular profile which start at the distal end of the shank, the width of the in-cut of said rectangular profile is wider than the diameter of said cross pins, which are designed to seat and roll in them, said opposing spiral cam slots covering a rotational movement of the bolt fastener of more than 90 degrees, and up to 120 degrees, the track of the opposing spiral cam slot entering vertical at the distal end of the bolt fastener and curving into a shallow straight helix, without any radius component, until it reaches the summit area of the profile, here called the dead point, said summit area covering 40 degrees of rotational movement of the bolt fastener, in a shallow curve incline and when leaving it downward ending in a retention area.

12. The improved high strength fastener system as set forth in claim 11 wherein said bolt fastener has on its underside of the head a concentric groove which accommodates an o-ring made of resilient material, when said bolt fastener is in locked position, the bolt fastener head will press against the retaining bracket and create a seal, preventing external moisture and dirt to enter the inside of the fastening system.

13. The improved high strength fastener system as set forth in claim 11 wherein said bolt fastener shank has a rounded opposing spiral cam slot groove.

14. The improved high strength fastener system as set forth in claim 11 wherein said bolt fastener shank has a tapered opposing spiral cam slot groove.

15. The improved high strength fastener system as set forth in claim 1 wherein the arrangement of the disc springs creates a larger spring force, said disc springs are stacked in parallel, meaning their conical surface touches against the next disc springs conical surface, a parallel packet has 2 or more disc springs stacked this way, the disc spring packets are than stacked in series meaning the larger or smaller peripheral edges of the disc springs touch each other, this way the spring force can be doubled or more, the disk spring chamber of the housing is elongated and the bolt fastener is longer to accommodate the added disc springs.

16. The improved high strength fastener system as set forth in claim 1 wherein a strong helical coiled spring is seated and captured between said pin ring and the housing lid, said housing has a straight cylindrical wall, the outside diameter of said strong helical coiled spring is slightly smaller than the inside diameter of the housing wall.

17. An improved high strength fastener system for removably attaching a first work piece in biased engagement with a second work piece comprising:
a) a housing having a central axis forming a hollow space, having a cylindrical side wall and a cylindrical inner wall-surface and a flange for attachment to the first work piece, a bottom, and forming an upper and a lower chamber divided with a step between them, the lower chamber having an anti rotation means, having a drain hole placed in the center of said bottom, the upper chamber at the upper end having a snap ring groove on the inside diameter of the housing wall, retaining
b) a snap ring placed in the groove, capturing
c) 3 or more biasing members inside said housing each biasing member comprising of a disc spring, stacked in parallel and in an accordion type manner, sandwiched between said snap ring, and
d) a pin ring having a tube like cylindrical outer surface and an internal bore, being slide-ably connected to said cylindrical inner wall surface of said housing and having an anti rotation means against said housing, slide-ably touching said anti rotation means of said housing, having two horizontal radial bores to accommodate
e) a pair of cross pin means, said cross pin means being slide-ably movable around their axis, seated in the pin ring and each extending with one end toward
f) a bolt fastener, comprising of an enlarged head, a smaller diameter shank, an even smaller diameter neck, located adjacent to the head, said shank having two opposing spiral cam slots, said cam slots having a dead point and a retention area in said cam slots, said cross pin ends being adapted to be located within said opposing spiral cam slots, said bolt fastener being able to slid-ably move along its axis, being capture by
g) a retaining bracket, said retaining bracket having a slightly smaller crimped aperture than the shank diameter of the fastening bolt and capturing said fastening bolt along the length of the neck area, said retaining bracket being attached by fastening means to the second work piece,
h) a helical spring seated between said bolt fastener and said bottom of the housing urging said bolt fastener out of said housing when said bolt fastener is in the extended free position.
i) a plurality of rivets or other fastening means to attach the housing to the first work piece;
wherein;
the bolt fastener when rotated will force said cross pin ends to climb said opposing spiral cam slots, reaching over the dead point and snapping into the retaining area of said opposing spiral cam slots, and force said pin ring in an axial movement against said disc springs and compressing said disc springs held in place by said snap ring, creating a resilient biasing force and consequently pressing the second work piece against the first work piece.

18. The improved high strength fastener system as set forth in claim 17 wherein a self clinching serrated toothed rim with a shoulder in-cut at the upper outer end of the housing is pressed into the bore of the first work piece which creates a solid mounting for the receptacle.

19. An improved high strength fastener system for removably attaching a first work piece in biased engagement with a second work piece, comprising:
a) a housing having a central axis forming a hollow space, having a cylindrical side wall and a cylindrical inner wall-surface and a bottom, and at the lower end having an anti rotation means, on its upper end having a housing flange with mounting holes,
c) an integrated element having a cylindrical outer surface and an internal bore concentric to the outer diameter, said cylindrical outer diameter has a loose fit with the inside diameter of said housing, said integrated element has on its upper end a flange with the same outlines as the housing flange and is attached to said housing flange by rivets, said integrated element has on its upper end a spiral helical in cut, cutting thru the wall of the integrated element for several revolutions and in this way forming a helical spring type in cut, said integrated element has on its lower area below said spiral helical in cut an anti rotation mean, said anti rotation mean touching the anti rotation means of the housing, said integrated element has below said spiral helical in cut 2 radial bores cutting thru both walls to accommodate
d) a pair of cross pins, said cross pins being slide-ably movable around their axis, seated in the integrated element and each extending with one end toward
e) a bolt fastener, comprising of an enlarged head, a smaller diameter shank, an even smaller diameter neck, located adjacent to the head, said shank having two opposing spiral cam slots, said cam slots having a dead point and a retention area, said cross pin ends being adapted to be located within said opposing spiral cam slots, said bolt fastener being able to slid-ably move along its axis, being captured by
f) a retaining bracket, said retaining bracket having a slightly smaller crimped aperture than the shank diameter of the fastening bolt and capturing said fastening bolt along the length of the neck area, said retaining bracket being attached by fastening means to the second work piece,
g) a helical spring means urging said bolt fastener out of said housing, when said bolt fastener is in the extended free position to show to the operator that said bolt fastener is not engaged,
h) a plurality of rivets or other fastening means to attach said integrated element and housing to the second work piece;
whereby;
when rotating the bolt fastener with a tool said bolt fastener will force said cross pin ends to climb said opposing spiral cam slots, reaching over the dead point and snapping into the retaining area of said opposing spiral cam slots, and force the lower part of the integrated element below the spiral in cut to move axially against said helical spring in cut and compressing said helical spring in cut, creating a resilient biasing force and consequently pressing the second work piece against the first work piece.
